(19) United States
(12) Patent Application Publication
(10) Pub. No.: US 2025/0385295 A1
(43) Pub. Date: Dec. 18, 2025

(54) PRESSURIZATION DEVICE FOR SECONDARY BATTERY

(71) Applicant: SAMSUNG SDI CO., LTD., Yongin-si, Gyeonggi-do (KR)

(72) Inventors: Jeong Hoon KIM, Yongin-si, Gyeonggi-do (KR); Mansoo SHIN, Yongin-si, Gyeonggi-do (KR)

(21) Appl. No.: 18/860,783

(22) PCT Filed: Apr. 27, 2023
(86) PCT No.: PCT/KR2023/005805

§ 371 Date: Aug. 18, 2025

(30) Foreign Application Priority Data
Apr. 28, 2022 (KR) 10-2022-0052670

(51) Int. Cl. H01M 10/04; H01M 50/103; H01M 50/105

(52) U.S. Cl. CPC H01M 10/0481; H01M 50/103; H01M 50/105

(57) ABSTRACT

The present invention provides a pressurization device for a secondary battery that can be used multiple times. As one embodiment, as a device for pressurizing an electrode unit in which an electrolyte is stacked between electrode plates, disclosed is a pressurization device for a secondary battery, comprising: a die having a cavity accommodating the electrode unit; a sealing container having an opening and accommodating the die in an inner space; and a sealing cover engaged with the opening of the sealing container and sealing the electrode unit with the sealing container, wherein the sealing cover under the sealing container is composed of an elastic member

### TECHNICAL FIELD

The present disclosure relates to a pressurization device for secondary battery that may be used multiple times.

### BACKGROUND ART

A secondary battery is a power storage system that provides excellent energy density by converting electrical energy into chemical energy and storing it. Compared to primary battery, which cannot be recharged, secondary battery can be recharged and are widely used in IT devices such as smartphones, cellular phones, laptops, and tablet PCs. Recently, interest in electric vehicles has increased to prevent environmental pollution, and accordingly, high-capacity secondary battery is being adopted for electric vehicles. This secondary battery is required to have characteristics such as high density, high output, and stability.

Such a lithium ion secondary battery is provided with a positive electrode layer, a negative electrode layer, and an electrolyte layer disposed between them. For example, a non-aqueous liquid or solid is used as the electrolyte layer. When liquid (hereinafter referred to as ‘electrolyte’) is used in the electrolyte layer, the electrolyte may easily penetrate into the interior of the positive layer or negative layer. Therefore, since the interfacial resistance between the active material of the positive electrode layer or the negative electrode layer (hereinafter referred to as ‘electrode layer’) and the electrolyte is reduced, battery performance may be improved. However, since the electrolyte is flammable, various additional complex systems are required to ensure safety.

On the other hand, since the solid electrolyte (hereinafter referred to as ‘solid electrolyte’) is non-flammable, the complex system as described above may be simplified. Therefore, a lithium ion secondary battery (hereinafter referred to as a ‘solid battery’) comprising a layer containing a non-flammable solid electrolyte (hereinafter referred to as a ‘solid electrolyte layer’) has been proposed. However, when using a solid electrolyte, an ultra-high-pressure process is required to densify the structures of the positive layer, solid electrolyte, and negative layer.

### DISCLOSURE

### Technical Problem

The present disclosure provides a pressurization device for a secondary battery that can be used multiple times.

### Technical Solution

A pressurization device for a secondary battery according to the present disclosure is a device for pressurizing an electrode unit in which electrolyte is stacked between electrode plates. The pressurization device comprising; a die comprising a cavity to accommodate the electrode unit; a sealed container comprising an opening and receiving the die through an interior space; and a sealing cover coupled to the opening of the sealed container and sealing the electrode unit with the sealed container, and the sealed container and the sealed cover comprises an elastic member.

The cavity is formed on a first surface of the die and a second surface corresponding to the first surface, and the electrode unit is accommodated in each cavity.

A plurality of electrode units is accommodated in the cavity, and the pressurization device further comprising; an intermediate film formed between a plurality of electrode units; and a laminating film coupled to the die to cover the electrode units.

The pressurization device further comprises a pouch externally surrounding the sealed container and the sealed cover.

The sealed container and the sealed cover accommodated inside the pouch are coupled in a vacuum state.

The pressurization device further comprises a sealing tape coupled along a border where the sealed container and the sealed cover come into contact.

The sealing cover comprises a groove formed along the longitudinal direction and a hole connecting with one side of the groove and the outside.

The hole is formed perpendicular to the longitudinal direction of the groove.

The pressurization device further comprises a stopper coupled to the hole and a finishing tape coupled to an outer surface of the stopper.

The sealed container and sealed cover comprise at least one of rubber and silicone.

### Advantageous Effects

The pressurization device for a secondary battery according to the present disclosure applies isostatic pressure while accommodating the die and electrode unit therein through a sealed container and a sealed cover made of an elastic member. Accordingly, safe pressurization is achieved and the sealed container and sealed cover may be used multiple times. Therefore, costs may be reduced.

### DESCRIPTION OF DRAWINGS

FIG. 1a is a view showing a die of a pressurization device for a secondary battery according to an embodiment of the present disclosure.

FIG. 1b is sectional view taken along line A-A′ of FIG. 1a.

FIG. 2 is an exploded perspective view showing a structure in which a solid-state battery and a film are stacked on a die in the pressurization device for the secondary battery according to the embodiment of the present disclosure.

FIG. 3a is a perspective view of the lamination of FIG. 2 in a completed state.

FIG. 3b is sectional view taken along line B-B′ of FIG. 3a.

FIG. 4 is a view showing a sealed container and a sealed cover in the pressurization device for the secondary battery according to the embodiment of the present disclosure.

FIG. 5 is an exploded perspective view showing a process in which the die is inserted into a pouch while being inserted into the sealed container and the sealed cover in the pressurization device for the secondary battery according to the embodiment of the present disclosure.

FIG. 6a is a perspective view of the state in which the coupling of FIG. 5 is completed.

FIG. 6b is sectional view taken along line C-C′ of FIG. 6a.

FIG. 7 is a view showing a state in which the pressurization device for the secondary battery pressurizes the solid-state battery coupled to the die according to the embodiment of the present disclosure.

FIG. 8 is a view showing a sealing tape, a stopper, and a finishing tape coupled to the sealed container and the sealed cover in the pressurization device for the secondary battery according to another embodiment of the present disclosure.

FIG. 9a is a perspective view of the state in which the coupling of FIG. 8 is completed.

FIG. 9b is sectional view taken along line D-D′ of FIG. 9a.

FIG. 10 is a view showing a state in which the pressurization device for the secondary battery pressurizes the solid-state battery coupled to the die according to another embodiment of the present disclosure.

### SEQUENCE LIST TEXT

10; die 11; cavity
20; intermediate film 30; laminating film
40; sealed container 50; seal cover
60; pouch 70; sealing tape
80; stopper 90; finishing tape
100; electrode unit

### MODE FOR INVENTION

Hereinafter, preferable embodiments of the present disclosure will be described in detail with reference to the accompanying drawings.

The embodiments of the present disclosure are provided to more completely describe the present disclosure to those skilled in the art, the following embodiments may be modified into various other forms, and the scope of the present disclosure is not limited to the following embodiments. Rather, these embodiments are provided to make the present disclosure more meaningful and complete, and to fully convey the spirit of the present disclosure to those skilled in the art.

In addition, in the accompanying drawings, sizes or thicknesses of various components are exaggerated for brevity and clarity. Like numbers refer to like elements throughout. As used herein, the term “and/or” includes any and all combinations of one or more of the associated listed items. In addition, it will be understood that when an element A is referred to as being “connected to” an element B, the element A can be directly connected to the element B or an intervening element C may be present and the element A and the element B are indirectly connected to each other.

The terminology used herein is for the purpose of describing particular embodiments only and is not intended to be limiting of the invention. As used herein, the singular forms are intended to include the plural forms as well, unless the context clearly indicates otherwise. It will be further understood that the terms “comprise or include” and/or “comprising or including,” when used in this specification, specify the presence of stated features, numbers, steps, operations, elements, and/or components, but do not preclude the presence or addition of one or more other features, numbers, steps, operations, elements, components, and/or groups thereof.

It will be understood that, although the terms first, second, etc. may be used herein to describe various members, elements, regions, layers and/or sections, these members, elements, regions, layers and/or sections should not be limited by these terms. These terms are only used to distinguish one member, element, region, layer and/or section from another. Thus, for example, a first member, a first element, a first region, a first layer and/or a first section discussed below could be termed a second member, a second element, a second region, a second layer and/or a second section without departing from the teachings of the present invention.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “on” or “above” the other elements or features. Thus, the exemplary term “below” can encompass both an orientation of above and below.

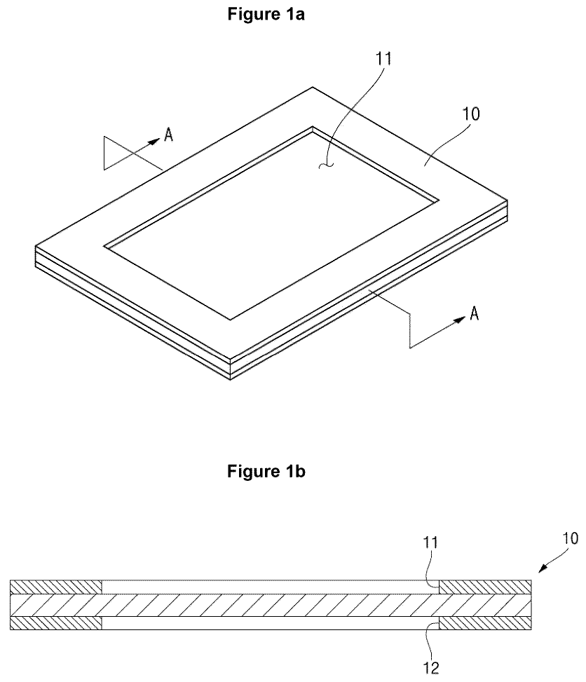

FIG. 1a is a view showing a die of a pressurization device for a secondary battery according to an embodiment of the present disclosure. FIG. 1b is sectional view taken along line A-A′ of FIG. 1a.

Referring to FIGS. 1A and 1B, the die 10 used in the pressurization device for a secondary battery according to an embodiment of the disclosure may include cavities 11 formed on the first surface (e.g., the upper surface) and the second surface (e.g., the lower surface) opposite to the first surface. In addition, the cavity 11 may be recessed inward from an approximately central region of each surface of the die 10.

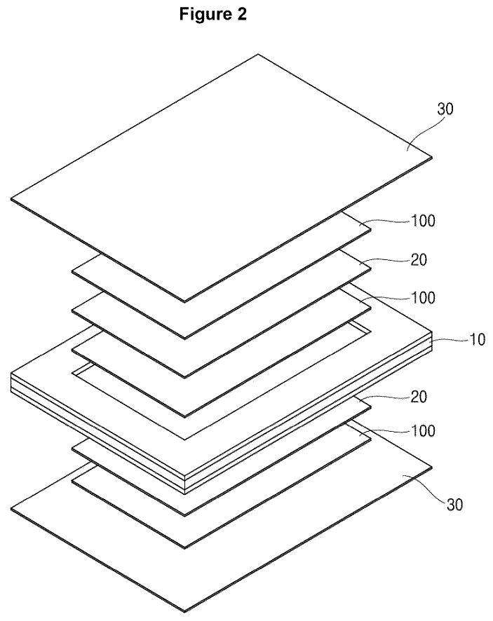

FIG. 2 is an exploded perspective view showing a structure in which a solid-state battery and a film are stacked on a die in the pressurization device for the secondary battery according to the embodiment of the present disclosure.

Referring to FIG. 2, an electrode unit 100 may be stacked in the cavity 11 of the die 10. In detail, a pair of electrode units 100 may be allocated to each side of the die 10, and a pair of electrode units 100 may be inserted and coupled to each cavity. The electrode unit 100 may be a solid-state battery unit in which a positive electrode plate, a solid electrolyte, and a negative electrode plate are stacked. Also, a plurality of electrode units 100 may be stacked after processing to form a battery cell.

In detail, an intermediate film 20 may be disposed between a pair of electrode units 100 inserted into the cavity 11. Each cell of the electrode unit 100 may be electrically separated through the intermediate film 20. Also, after the electrode unit 100 is inserted, the laminating film 30 may be coupled to the outer surface to seal the cavity 11. The intermediate film 20 and the laminating film 30 may include polyethylene (PE), polypropylene (PP), and polystyrene (PS). However, the intermediate film 20 and the laminating film 30 are not limited thereto and may include various materials.

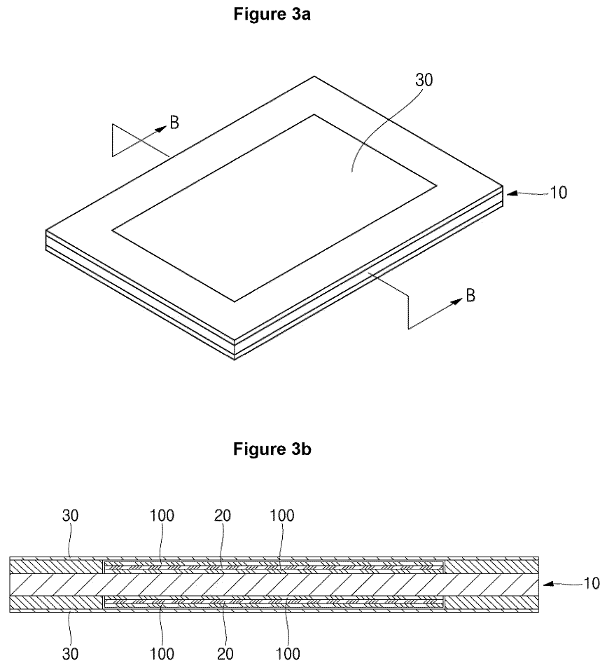

FIG. 3a is a perspective view of the lamination of FIG. 2 in a completed state. FIG. 3b is sectional view taken along line B-B′ of FIG. 3a.

Referring to FIGS. 3A and 3B, a pair of electrode units 100 are respectively inserted into the cavities 11 formed on the first and second surfaces of the die 10. As described above, the intermediate film 20 is located between the pair of electrode units 100 accommodated in the cavity 11. After the electrode unit 100 is accommodated, the laminating film 30 may be coupled to the first and second surfaces of the die 10 to seal the electrode unit 100.

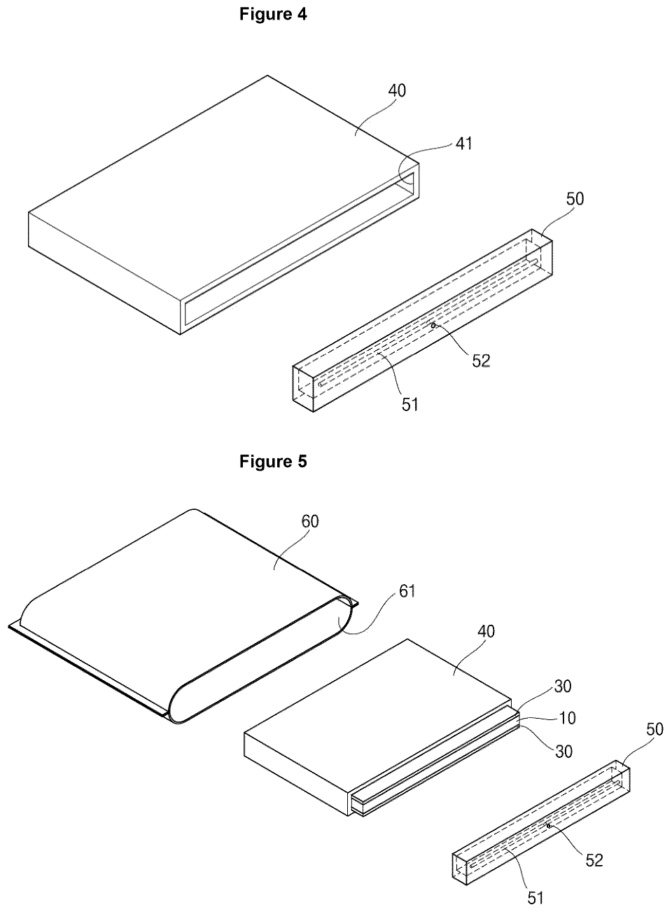

FIG. 4 is a view showing a sealed container and a sealed cover in the pressurization device for the secondary battery according to the embodiment of the present disclosure.

Referring to FIG. 4, the sealed container 40 includes an opening, and a space 41 for accommodating the die 10 is formed inside the opening. The sealed container 40 may include an elastic material. For example, the sealed container 40 may include rubber or silicone. As will be explained below, when a vacuum is formed by sucking air from the outside, the sealed container 40 may recover again due to its elasticity. Therefore, the sealed container 40 may be used multiple times.

Also, a sealing cover 50 may be coupled to the opening of the sealed container 40. The sealing cover 50 may be coupled to the opening of the sealing container 40 in a state in which the die 10, the electrode assembly 100, the intermediate film 20, and the laminating film 40 are inserted into the sealing container 40. The sealing cover 50 may include the same elastic material as the sealed container 40.

Therefore, when the coupling structure of the sealing container 40 and the sealing cover 50 is vacuum sealed by sucking air from the outside, the space inside the sealing container 40 and the sealing cover 50 is reduced by an external force, and thus, the space may be in close contact with configurations such as the inner die 10 and the electrode unit 100. Also, as the internal space decreases, a path through which the internal air flows out of the sealing container 40 and the sealing cover 50 is required. Accordingly, the sealing cover 50 may include a groove 51 formed along the longitudinal direction, and a hole 52 connecting the groove 51 with the outside. The air located inside the sealing container 40 and the sealing cover 50 moves along groove 51 and is collected approximately in the center of groove 51. Air may be exhausted to the outside through the hole 52 at that location.

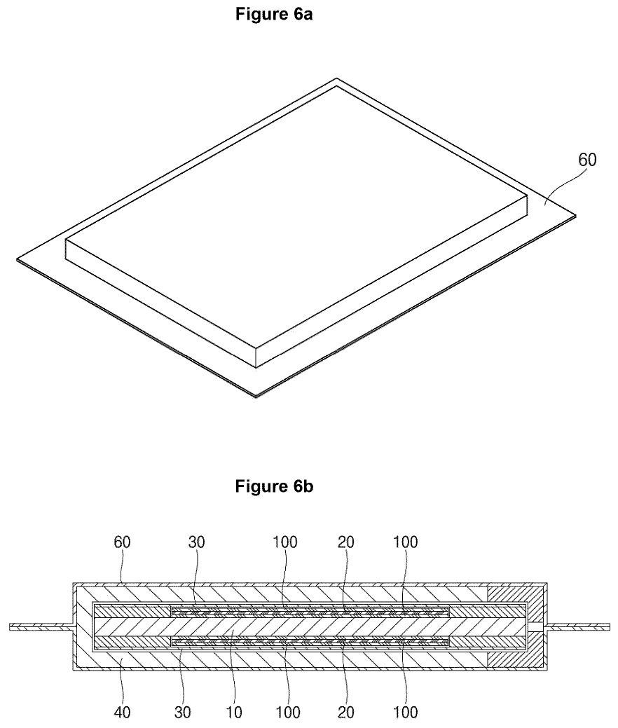

FIG. 5 is an exploded perspective view showing a process in which the die is inserted into a pouch while being inserted into the sealed container and the sealed cover in the pressurization device for the secondary battery according to the embodiment of the present disclosure. FIG. 6a is a perspective view of the state in which the coupling of FIG. 5 is completed. FIG. 6b is sectional view taken along line C-C′ of FIG. 6a.

Referring to FIG. 5, a separate pouch 60 may be further coupled to the outside of the sealing container 40 and the sealing cover 50. The pouch 60 may be formed in a pouch shape that is deformable by pressure.

Also, referring to FIGS. 6A and 6B, air inside the pouch 60 is sucked from the outside in a state in which the sealing container 40 and the sealing cover 50 are inserted into the pouch 60. Accordingly, the pouch 60 is deformed into the shapes of the sealing container 40 and the sealing cover 50. Accordingly, the pouch 60 may closely contact the sealing container 40 and the sealing cover 50. Also, air of the sealing container 40 and the sealing cover 50 is discharged to the outside through the grooves 51 and the holes 52. Accordingly, the sealing container 40 and the sealing cover 50 may closely contact the inner die 10, the electrode unit 100, and the films 20 and 30.

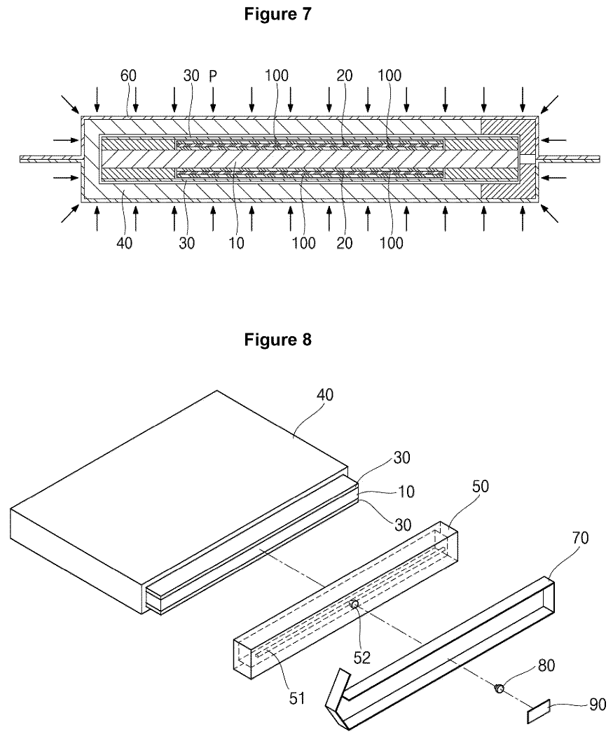

FIG. 7 is a view showing a state in which the pressurization device for the secondary battery pressurizes the solid-state battery coupled to the die according to the embodiment of the present disclosure.

Referring to FIG. 7, in the previous state, isostatic pressure, that is, uniform pressure P may be applied to all surfaces of the pouch 60. The method of applying the pressure may be performed through a Wet Isostatic Press (WIP) facility. The WIP method is a wet process using a fluid such as water or oil as a pressure medium, and a uniform pressure P may be applied by placing a structure sealed through the pouch 60 in the corresponding medium. In addition, through this pressure, the coupling of the positive electrode plate, the solid electrolyte, and the negative electrode plate of the electrode unit 100 located inside the structure may be dense. Accordingly, ion conductivity may be increased.

In this case, since the sealing container 40 and the sealing cover 50 are sealed in the pouch 60, the sealing container 40 and the sealing cover 50 do not come into contact with the fluid. Further, since the sealing container 40 and the sealing cover 50 include an elastic material, the original appearance may be maintained through elastic restoration. Therefore, if the pouch 60 is removed after the isotropic pressing is completed, the sealing container 40 and the sealing cover 50 therein may be reused. Therefore, it is possible to reduce the pressing cost of the secondary battery.

Hereinafter, a pressurization device for a secondary battery according to another embodiment of the present disclosure will be described.

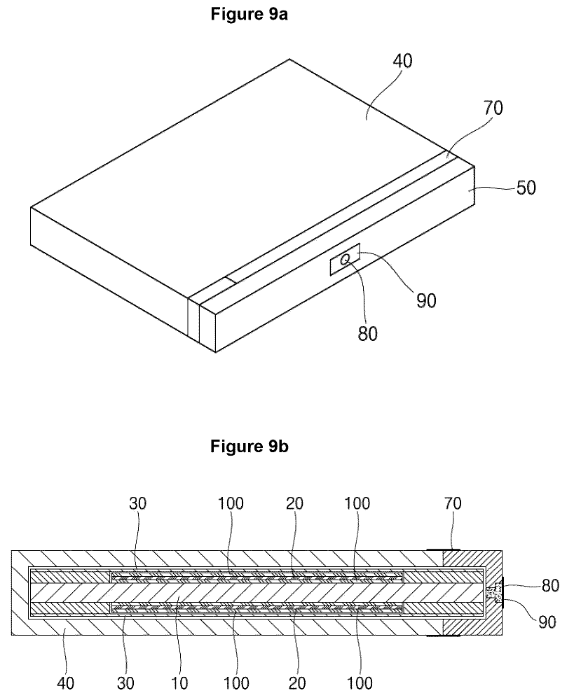

FIG. 8 is a view showing a sealing tape, a stopper, and a finishing tape coupled to the sealed container and the sealed cover in the pressurization device for the secondary battery according to another embodiment of the present disclosure. FIG. 9a is a perspective view of the state in which the coupling of FIG. 8 is completed. FIG. 9b is sectional view taken along line D-D′ of FIG. 9a.

Referring to FIGS. 8 to 9b, the pressurization device for a secondary battery according to another embodiment of the present disclosure may further include a sealing tape 70, a stopper 80, and a finishing tape 90 coupled to the sealing container 40 and the sealing cover 50.

The sealing tape 70 may be adhered along the boundary surface in a state in which the sealing container 40 and the sealing cover 50 are coupled to each other. Accordingly, the boundary between the sealing container 40 and the sealing cover 50 is sealed. Therefore, the fluid used during the isotropic pressing does not penetrate through the boundary.

Also, the stopper 80 may be coupled to the hole 52 of the sealing cover 50, and the finishing tape 90 may be adhered to an outer surface thereof. In a state in which the sealing container 40, the sealing cover 50, and the sealing tape 70 are coupled, after internal air is exhausted to the outside through the hole of the sealing cover 50 to become a vacuum, the stopper 80 may block the hole 52 and the finishing tape 90 may be attached thereto. Accordingly, vacuum of the sealing container 40 and the sealing cover 50 may be maintained. Accordingly, the sealing container 40 and the sealing cover 50 may be in close contact with the inner die 10, the electrode unit 100, and the like.

In this case, the sealing container 40 and the sealing cover 50 are maintained in a sealed state through the sealing tape 70, the stopper 80, and the finishing tape 90. Therefore, unlike the above-described embodiment, an external separate pouch is not required. Therefore, the pressurization device for the secondary battery according to another embodiment of the present disclosure does not require a coupling/separation operation of a pouch. Therefore, the cost and the number of processes may be reduced.

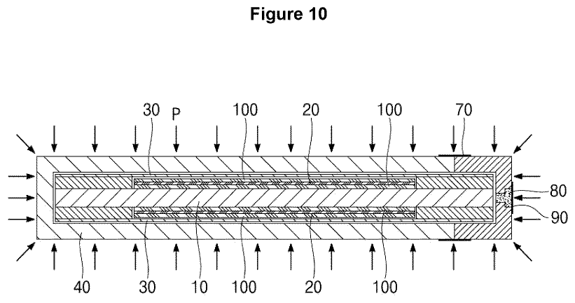

FIG. 10 is a view showing a state in which the pressurization device for the secondary battery pressurizes the solid-state battery coupled to the die according to another embodiment of the present disclosure.

In the state of FIG. 9a, the pressure P through the fluid may be applied from the outside, such that isotropic pressing may be performed. In this case, as described above, since the sealing state through the sealing tape 70, the stopper 80, and the finishing tape 90 is maintained, fluid does not penetrate into the sealing container 40 and the sealing cover 50. Accordingly, a safe pressing process may be performed.

The above description is only one example for implementing the pressurization device for the secondary battery according to the present disclosure. Embodiments of the present disclosure are not limited to the above embodiments. Various modifications and variations can be made thereto by those skilled in the art within the spirit of the present disclosure and the equivalent scope of the appended claims.

1. A pressurization device for a secondary battery for pressurizing an electrode unit in which an electrolyte is stacked between electrode plates,
wherein pressurization device comprising;
a die comprising a cavity to accommodate the electrode unit;
a sealed container comprising an opening and receiving the die through an interior space; and
a sealing cover coupled to the opening of the sealed container and sealing the electrode unit with the sealed container,
wherein the sealed container and the sealed cover comprises an elastic member.

2. The pressurization device for a secondary battery of claim 1, wherein the cavity is formed on a first surface of the die and a second surface corresponding to the first surface,
wherein the electrode unit is accommodated in each cavity.

3. The pressurization device for a secondary battery of claim 1, wherein a plurality of electrode units is accommodated in the cavity,
wherein the pressurization device further comprising;
an intermediate film formed between a plurality of electrode units; and
a laminating film coupled to the die to cover the electrode units.

4. The pressurization device for a secondary battery of claim 1, wherein the pressurization device further comprises a pouch externally surrounding the sealed container and the sealed cover.

5. The pressurization device for a secondary battery of claim 4, wherein the sealed container and the sealed cover accommodated inside the pouch are coupled in a vacuum state.

6. The pressurization device for a secondary battery of claim 1, wherein the pressurization device further comprises a sealing tape coupled along a border where the sealed container and the sealed cover come into contact.

7. The pressurization device for a secondary battery of claim 1, wherein the sealing cover comprises a groove formed along the longitudinal direction and a hole connecting with one side of the groove and the outside.

8. The pressurization device for a secondary battery of claim 7, wherein the hole is formed perpendicular to the longitudinal direction of the groove.

9. The pressurization device for a secondary battery of claim 7, wherein the pressurization device further comprises a stopper coupled to the hole and a finishing tape coupled to an outer surface of the stopper.

10. The pressurization device for a secondary battery of claim 1, wherein the sealed container and sealed cover comprise at least one of rubber and silicone.
